(19) United States
(12) Patent Application Publication
(10) Pub. No.: US 2018/0139788 A1
(43) Pub. Date: May 17, 2018

(54) Establishing Emergency Calls on Mobile Devices

(71) Applicant: QUALCOMM Incorporated, San Diego, CA (US)

(72) Inventors: Vashishth Jhunjhunwala, Hyderabad (IN); Stephen William Edge, Escondido, CA (US); Hargovind Prasad Bansal, Hyderabad (IN)

(21) Appl. No.: 15/350,392

(22) Filed: Nov. 14, 2016

(51) Int. Cl. H04W 76/00; H04W 76/02; H04W 76/06; H04B 1/3816

(52) U.S. Cl. CPC H04W 76/007; H04W 76/025; H04W 88/06; H04B 1/3816; H04W 76/064

(57) ABSTRACT

Various methods for performing an emergency call on a mobile communication device having a first subscription and a second subscription may include receiving, from a user, an input to perform the emergency call on the first subscription, attempting to establish the emergency call on the first subscription, attempting to establish the emergency call on the second subscription, determining whether the emergency call has been established on either the first subscription or the second subscription, completing the emergency call on the first subscription and cancelling the attempt to establish the emergency call on the second subscription in response to determining that the emergency call has been established on first subscription, and completing the emergency call on the second subscription and cancelling the attempt to establish the emergency call on the first subscription in response to determining that the emergency call has been established on second subscription.

### BACKGROUND

Some designs of mobile communication devices—such as smart phones, tablet computers, and laptop computers—contain one or more Subscriber Identity Module (SIM) cards that provide users with access to multiple separate mobile telephony networks. Examples of radio access technologies (RATs) used by mobile telephony networks include Third Generation (3G), Fourth Generation (4G), Long Term Evolution (LTE), Time Division Multiple Access (TDMA), Code Division Multiple Access (CDMA), CDMA 2000, Wideband CDMA (WCDMA), Global System for Mobile Communications (GSM), Single-Carrier Radio Transmission Technology (1xRTT), and Universal Mobile Telecommunications Systems (UMTS). A mobile communication device may utilize a particular RAT to communicate with a network corresponding to a SIM.

A wireless communication device that includes one or more SIMs and connects to two or more separate mobile telephony networks using a shared radio frequency (RF) resource/radio may be termed a multi-SIM multi-standby (MSMS) communication device. An example of an MSMS communication device is a dual-SIM dual standby (DSDS) communication device, which includes two SIM cards supporting two subscriptions associated with different RATs sharing one RF resource. In DSDS communication devices, the separate subscriptions share the one RF resource to communicate with two separate mobile telephony networks on behalf of their respective subscriptions. When one subscription is using the RF resource, the other subscription is in stand-by mode and is not able to communicate using the RF resource.

Another type of multi-SIM mobile communication device is a multi-SIM multi-active (MSMA) device that is configured with multiple RF resources that support multiple SIMs allowing two or more subscriptions to be monitored simultaneously even when a call is underway on one subscription. An example of an MSMA device is a dual-SIM dual-active (DSDA) device with two RF resources and two SIMs/subscriptions. Each SIM, or subscription, may utilize one of the RF resources for communication and thus multiple subscriptions may be actively communicating at the same time.

### SUMMARY

Various examples of methods for performing an emergency call on a mobile communication device having a first subscription and a second subscription may include receiving, from a user, an input to perform the emergency call on the first subscription, attempting to establish the emergency call on the first subscription, attempting to establish the emergency call on the second subscription, determining whether the emergency call has been established on either the first subscription or the second subscription, completing the emergency call on the first subscription and cancelling the attempt to establish the emergency call on the second subscription in response to determining that the emergency call has been established on first subscription, and completing the emergency call on the second subscription and cancelling the attempt to establish the emergency call on the first subscription in response to determining that the emergency call has been established on second subscription.

Some examples may further include waiting for a timer to expire between attempting to establish the emergency call on the first subscription and attempting to establish the emergency call on the second subscription. In some embodiments, waiting for the timer to expire may include starting the timer upon attempting to establish the emergency call on the first subscription, and determining whether the first subscription has successfully established the emergency call after the timer expires, in which attempting to establish the emergency call on the second subscription is performed in response to determining that the first subscription has not successfully established the emergency call after expiry of the timer.

In some examples, attempting to establish the emergency call on the first subscription and attempting to establish the emergency call on the second subscription are performed approximately simultaneously. Some examples may further include continuing to attempt to establish the emergency call on the first subscription and on the second subscription in response to determining that the emergency call has not been established on either the first subscription or the second subscription.

In some examples, the mobile communication device is a multi-subscriber identity module (SIM), multi-active mobile communication device, and attempting to establish the emergency call on the first subscription and attempting to establish the emergency call on the second subscription are performed using respective radio frequency resources. In some examples, the mobile communication device is a multi-subscriber identity module (SIM), multi-standby mobile communication device, and attempting to establish the emergency call on the second subscription is performed over a wireless local area network connection. In some examples, cancelling the attempt to establish the emergency call on the first subscription or the second subscription may include deactivating the emergency call.

Further examples include a mobile communication device including a memory and a processor configured to perform operations of the methods summarized above. Further examples include a non-transitory processor-readable storage medium having stored thereon processor-executable software instructions configured to cause a processor of a mobile communication device to perform operations of the methods summarized above. Further examples include a mobile communication device that includes means for performing functions of the operations of the methods summarized above.

### BRIEF DESCRIPTION OF THE DRAWINGS

The accompanying drawings, which are incorporated herein and constitute part of this specification, illustrate examples, and together with the general description and the detailed description given herein, serve to explain the features of the disclosed systems and methods.

FIG. 1 is a communication system block diagram of mobile telephony networks suitable for use with various examples.

FIG. 2 is a component block diagram of a multi-SIM mobile communication device according to various examples.

FIG. 3 is a system architecture diagram illustrating example protocol layer stacks implemented by the mobile communication device of FIG. 2 according to various examples.

FIG. 4 is a call flow diagram illustrating performance of an emergency call according to conventional methods.

FIGS. 5A and 5B are call flow diagrams illustrating performance of an emergency call according to various examples.

FIGS. 6A and 6B are process flow diagrams illustrating methods for performing an emergency call on a mobile communication device according to various examples.

FIG. 7 is a component block diagram of a mobile communication device suitable for implementing some example methods.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

Various examples include improved methods for performing an emergency call on a multi-SIM mobile communication device having a first subscription and a second subscription. Leveraging the dual communication capabilities, the emergency call is attempted on both subscriptions at approximately the same time, and when one emergency call is successfully established on one subscription, the other emergency call on the other subscription is cancelled. This avoids the delay in completing an emergency call that may occur when the attempt to establish the emergency call on the first subscription fails and the emergency call is then attempted on the second subscription.

As used herein, the term “mobile communication device,” “multi-SIM mobile communication device,” or “multi-SIM device” refers to any one or all of cellular telephones, smart phones, personal or mobile multi-media players, personal data assistants, laptop computers, tablet computers, smart books, smart watches, palm-top computers, wireless electronic mail receivers, multimedia Internet-enabled cellular telephones, wireless gaming controllers, and similar personal electronic devices that includes one or more SIM cards, a programmable processor, memory, and circuitry for connecting to at least two mobile communication network with one or more shared RF resources. Various examples may be useful in mobile communication devices, such as smart phones, and so such devices are referred to in the descriptions of various examples. However, the examples may be useful in any electronic devices that may individually maintain one or more subscriptions that utilize one or more RF resources, which may include one or more of antennae, radios, transceivers, etc.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

Multi-SIM mobile communication devices may include two or more SIMs supporting two or more subscriptions. Some multi-SIM mobile communication devices may be MSMA devices in which each subscription may have dedicated RF resources and may be active at the same time. Other multi-SIM mobile communication devices may be MSMS devices in which the subscriptions share a single RF resource. When one subscription is active, the other subscriptions are idle, or inactive.

A user may use a subscription on a mobile communication device to make voice calls. One type of voice call is an emergency call, such as calls to police, ambulance, or fire departments. It is important that emergency calls be successfully completed quickly.

In a multi-SIM mobile communication device, a user may initiate an emergency call on a first subscription. In one example, the emergency call may be placed on the best subscription (e.g., voice over LTE (VOLTE) on the first subscription). The first subscription may experience delays or connection failures in completing the emergency calls, for example if the first subscription has a weak signal connection with its respective mobile telephony network. The mobile communication device may attempt to complete the call on the first subscription for several minutes or until a permanent failure of the first subscription occurs (which may take more than 120 seconds) before switching to a second subscription to attempt the emergency call. In emergency situations, this delay may result in serious consequences.

Various examples provide systems and methods implemented with a processor of a mobile communication device for performing an emergency call on a mobile communication device. The mobile communication device may be a multi-SIM device, such as an MSMS or MSMA device, having a first subscription and a second subscription. When a user of the mobile communication device initiates an emergency call on the first subscription, the processor may attempt to establish the emergency call on both the first subscription and the second subscription. Thus, even if the first subscription is unable to establish the emergency call quickly or at all, the second subscription may establish the emergency call without waiting for the first subscription to continue its attempts to successfully establish the emergency call. Both subscriptions may actively try to connect the emergency call independently of each other. Whichever subscription is able to establish the emergency call first is made the active subscription. The other subscription may cancel establishment of the emergency call and enter an idle state.

In some examples, an attempt to place the emergency call is made on a first subscription for a period of time before attempting the call on the second subscription. In such example, the processor may attempt to establish the emergency call on the first subscription and start a timer. When the timer expires, the processor may attempt to establish the emergency call on the second subscription as well. In other words, the second subscription may be utilized to establish the emergency call in parallel with the first subscription if the first subscription does not quickly establish the call.

If the mobile communication device is an MSMA device, each subscription may attempt to complete the call using its dedicated RF resource. If the mobile communication device is an MSMS device, the first subscription may utilize the RF resource to attempt to complete the call while the second subscription may utilize a Wi-Fi connection or another local area network (LAN) connection.

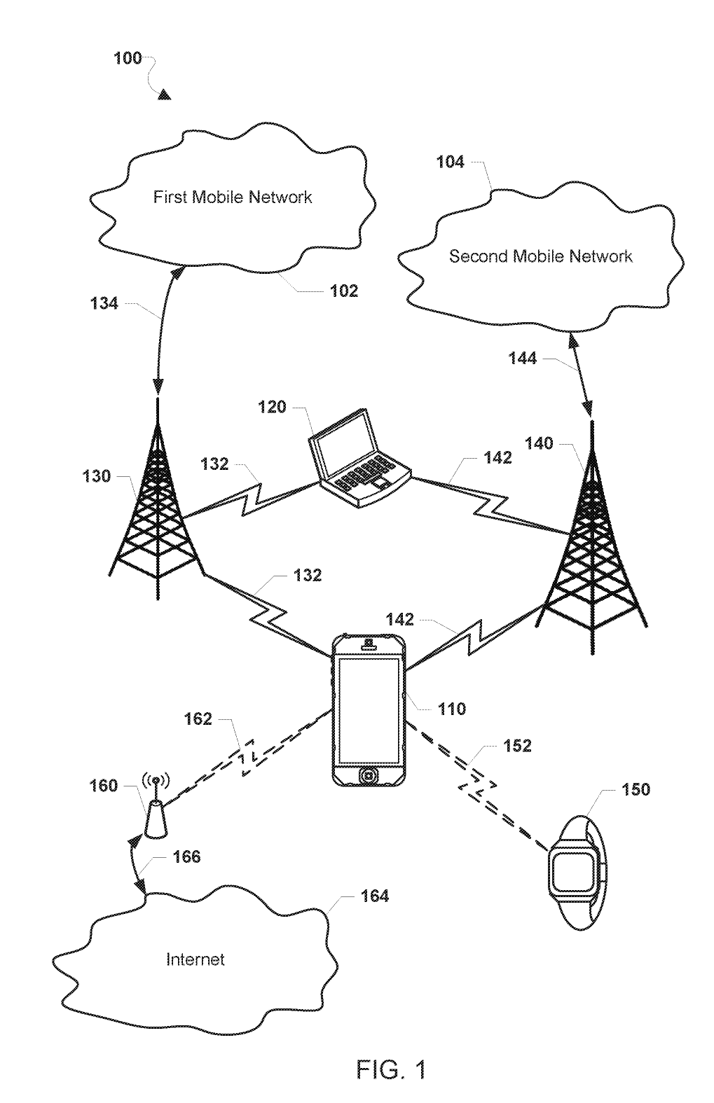

Various examples may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first mobile communication device 110 may be in communication with the first mobile network 102 through a cellular connection 132 to the first base station 130. The first mobile communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second mobile communication device 120 may similarly communicate with the first mobile network 102 through the cellular connection 132 to the first base station 130. The second mobile communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the mobile communication devices 110, 120 are shown connected to the first mobile network 102 and, optionally, to the second mobile network 104, in some examples (not shown), the mobile communication devices 110, 120 may include two or more subscriptions to two or more mobile networks and may connect to those subscriptions in a manner similar to those described herein.

In some examples, the first mobile communication device 110 may optionally establish a wireless connection 152 with a peripheral device 150 used in connection with the first mobile communication device 110. For example, the first mobile communication device 110 may communicate over a Bluetooth® link with a Bluetooth-enabled personal computing device (e.g., a “smart watch”). In some examples, the first mobile communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second mobile communication device 120 may similarly be configured to connect with the peripheral device 150 and/or the wireless access point 160 over wireless links.

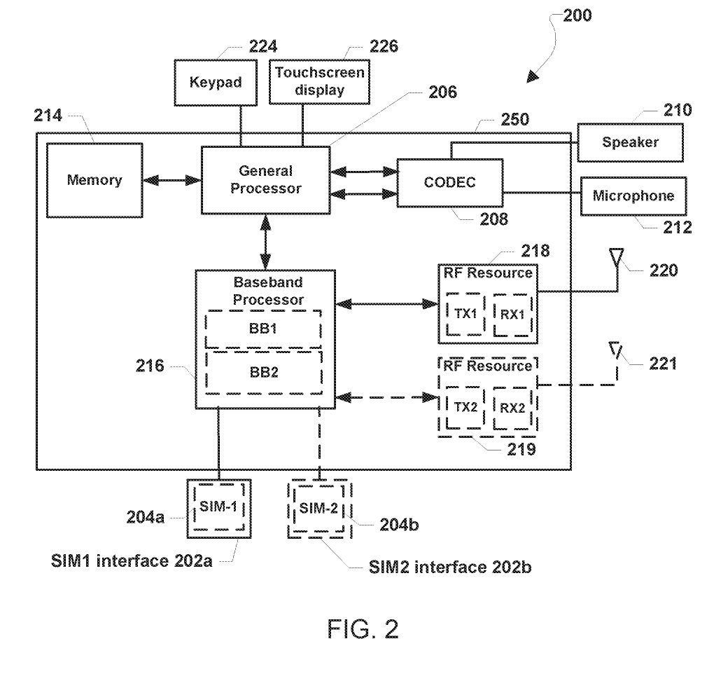

FIG. 2 is a functional block diagram of a multi-SIM mobile communication device 200 suitable for implementing various examples. With reference to FIGS. 1-2, the multi-SIM mobile communication device 200 may be similar to one or more of the mobile communication devices 110, 120 as described. The multi-SIM mobile communication device 200 may include a first SIM interface 202a, which may receive a first identity module SIM-1 204a that is associated with a first subscription. The multi-SIM mobile communication device 200 may also optionally include a second SIM interface 202b, which may receive an optional second identity module SIM-2 204b that is associated with a second subscription.

A SIM in various examples may be a Universal Integrated Circuit Card (UICC) that is configured with SIM applications, enabling access to, for example, GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a central processing unit (CPU), read only memory (ROM), random access memory (RAM), electrically erasable programmable read only memory (EEPROM) and input/out (I/O) circuits.

A SIM used in various examples may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (MD) pair, a Home Public Land Mobile Number (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM mobile communication device 200 (e.g., in a memory 214), and thus need not be a separate or removable circuit, chip or card.

The multi-SIM mobile communication device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain. The memory 214 may store an operating system (OS), as well as user application software and executable instructions.

The general processor 206 and the memory 214 may each be coupled to at least one baseband modem processor 216. Each SIM and/or RAT in the multi-SIM mobile communication device 200 (e.g., the SIM-1 204a and/or the SIM-2 204b) may be associated with a baseband-RF resource chain. A baseband-RF resource chain may include the baseband modem processor 216, which may perform baseband/modem functions for communications with/controlling a RAT, and may include one or more amplifiers and radios, referred to generally herein as RF resources (e.g., RF resource 218, 219). In some examples, baseband-RF resource chains may share the baseband modem processor 216 (i.e., a single device that performs baseband/modem functions for all RATs on the multi-SIM mobile communication device 200). In other examples, each baseband-RF resource chain may include physically or logically separate baseband processors (e.g., BB1, BB2).

The RF resource 218 may be a transceiver that performs transmit/receive functions for each of the SIMs/RATs on the multi-SIM mobile communication device 200. The RF resource 218 may include separate transmit and receive circuitry, or may include a transceiver that combines transmitter and receiver functions. In some examples, the RF resource 218 may include multiple receive circuitries. The RF resource 218 may be coupled to a wireless antenna (e.g., a wireless antenna 220). The RF resource 218 may also be coupled to the baseband modem processor 216. In some optional examples, the multi-SIM mobile communication device 200 may include an optional RF resource 219 configured similarly to the RF resource 218 and coupled to an optional wireless antenna 221.

In some examples, the general processor 206, the memory 214, the baseband processor(s) 216, and the RF resources 218, 219 may be included in the multi-SIM mobile communication device 200 as a system-on-chip 250. In some examples, the first and second SIMs 204a, 204b and the corresponding interfaces 202a, 202b to each subscription may be external to the system-on-chip 250. Further, various input and output devices may be coupled to components on the system-on-chip 250, such as interfaces or controllers. Example user input components suitable for use in the multi-SIM mobile communication device 200 may include, but are not limited to, a keypad 224, a touchscreen display 226, and the microphone 212.

In some examples, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-SIM mobile communication device 200 to enable communication between them, as is known in the art.

Functioning together, the two SIMs 204a, 204b, the baseband processor BB1, BB2, the RF resources 218, 219, and the wireless antennas 220, 221 may constitute two or more radio access technologies (RATs). For example, the multi-SIM mobile communication device 200 may be a LTE communication device that includes a SIM, baseband processor, and RF resource configured to support two different RATs, such as LTE, WCDMA, and GSM. More RATs may be supported on the multi-SIM mobile communication device 200 by adding more SIM cards, SIM interfaces, RF resources, and antennae for connecting to additional mobile networks.

In some examples (not shown), the multi-SIM mobile communication device 200 may include, among other things, additional SIM cards, SIM interfaces, a plurality of RF resources associated with the additional SIM cards, and additional antennae for supporting subscriptions communications with additional mobile networks.

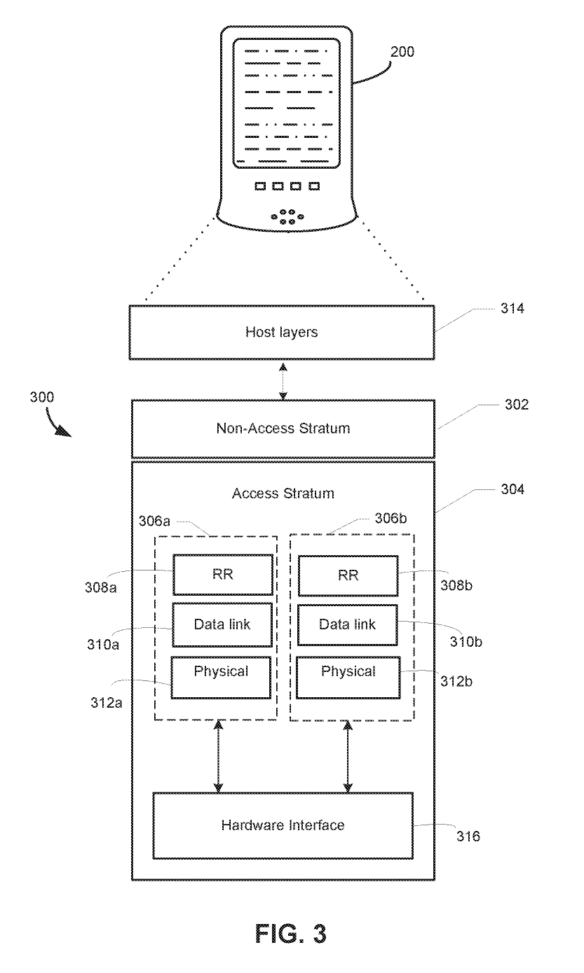

FIG. 3 illustrates an example of a software architecture with layered radio protocol stacks that may be used in data communications on a mobile communication device. Referring to FIGS. 1-3, the mobile communication device 200 may have a layered software architecture 300 to communicate over access networks associated with one or more SIMs. The software architecture 300 may be distributed among one or more processors, such as the baseband-modem processor 216.

The software architecture 300 may include a Non Access Stratum (NAS) 302 and an Access Stratum (AS) 304. The NAS 302 may include functions and protocols to support traffic and signaling for the one or more SIMs on the mobile communication device 200 (e.g., the SIM-1 204a and/or the SIM-2 204b) and their respective core networks. The AS 304 may include functions and protocols that support communication between each SIM (e.g., the SIM-1 204a and/or the SIM-2 204b) and entities of their respective access networks (e.g., a mobile switching center (MSC) in a GSM network, eNodeB in an LTE network, etc.).

In the mobile communication device 200, the AS 304 may include multiple protocol stacks, each of which may be associated with a different SIM. For example, the AS 304 may include protocol stacks 306a, 306b, associated with a first SIM subscription and a second SIM subscription, respectively. Although described below with reference to GSM-type communication layers, protocol stacks 306a, 306b may support any of variety of standards and protocols for wireless communications. In particular, the AS 304 may include at least three layers, each of which may contain various sublayers. For example, each protocol stack 306a, 306b may respectively include a Radio Resource (RR) sublayer 308a, 308b as part of Layer 3 (L3) of the AS 304 in a GSM or LTE signaling protocol. The RR sublayers 308a, 308b may oversee the establishment of a link between the mobile communication device 200 and associated access networks.

In the various embodiments, the NAS 302 and RR sublayers 308a, 308b may perform the various functions to search for wireless networks and to establish, maintain and terminate calls. Further, the RR sublayers 308a, 308b may provide functions including broadcasting system information, paging, and establishing and releasing a radio resource control (RRC) signaling connection between the mobile communication device 200 and the associated access network.

While not shown, the software architecture 300 may include additional Layer 3 sublayers, as well as various upper layers above Layer 3. Additional sub-layers may include, for example, connection management (CM) sub-layers (not shown) that route calls, select a service type, prioritize data, perform QoS functions, etc.

Residing below the Layer 3 sublayers (RR sublayers 308a, 308b), the protocol stacks 306a, 306b may also include data link layers 310a, 310b, which may be part of Layer 2 in a GSM or LTE signaling protocol. The data link layers 310a, 310b may provide functions to handle incoming and outgoing data across the network, such as dividing output data into data frames and analyzing incoming data to ensure the data has been successfully received In some embodiments, each data link layer 310a, 310b may contain various sublayers, such as a media access control (MAC) sublayer, a radio link control (RLC) sublayer, and a packet data convergence protocol (PDCP) sublayer, each of which form logical connections terminating at the access network. In various embodiments, a PDCP sublayer may provide uplink functions including multiplexing between different radio bearers and logical channels, sequence number addition, handover data handling, integrity protection, ciphering, and header compression. In the downlink, the PDCP sublayer may provide functions that include in-sequence delivery of data packets, duplicate data packet detection, integrity validation, deciphering, and header decompression.

In the uplink, the RLC sublayer may provide segmentation and concatenation of upper layer data packets, retransmission of lost data packets, and Automatic Repeat Request (ARQ). In the downlink, the RLC sublayer functions may include reordering of data packets to compensate for out-of-order reception, reassembly of upper layer data packets, and ARQ. In the uplink, the media access control (MAC) sublayer may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

Residing below the data link layers 310a, 310b, the protocol stacks 306a, 306b may also include physical layers 3.12a, 312b, which may establish connections over the air interface and manage network resources for the mobile communication device 200. In various embodiments, the physical layers 312a, 312b may oversee functions that enable transmission and/or reception over the air interface. Examples of such physical layer functions may include cyclic redundancy check (CRC) attachment, coding blocks, scrambling and descrambling, modulation and demodulation, signal measurements, MIMO, etc.

While the protocol stacks 306a, 306b provide functions to transmit data through physical media, the software architecture 300 may further include at least one host layer 314 to provide data transfer services to various applications in the mobile communication device 200. In other embodiments, application-specific functions provided by the at least one host layer 314 may provide an interface between the protocol stacks 306a, 306b and the general purpose processor 206. In some embodiments, the protocol stacks 306a, 306b may each include one or more higher logical layers (e.g., transport, session, presentation, application, etc.) that provide host layer functions. For example, in some embodiments, the software architecture 300 may include a network layer (e.g., Internet Protocol (IP) layer) in which a logical connection terminates at a gateway. In some embodiments, the software architecture 300 may include an application layer in which a logical connection terminates at another device (e.g., end user device, server, etc.). In some embodiments, the software architecture 300 may further include in the AS 304 a hardware interface 316 between the physical layers 312a, 312b and the communication hardware (e.g., one or more RF resource).

In various embodiments, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

As described, the modem stacks in various embodiments may support any of a variety of current and/or future protocols for wireless communications. For examples, the modem stacks in various embodiments may support networks using radio access technologies described in 3GPP standards (e.g., GSM, UMTS, LTE, etc.), 3GPP2 standards (e.g., 1xRTT/CDMA2000, evolution data optimized (EV-DO), etc.) and/or Institute of Electrical and Electronics Engineers (IEEE) standards (WiMAX, Wi-Fi, etc.).

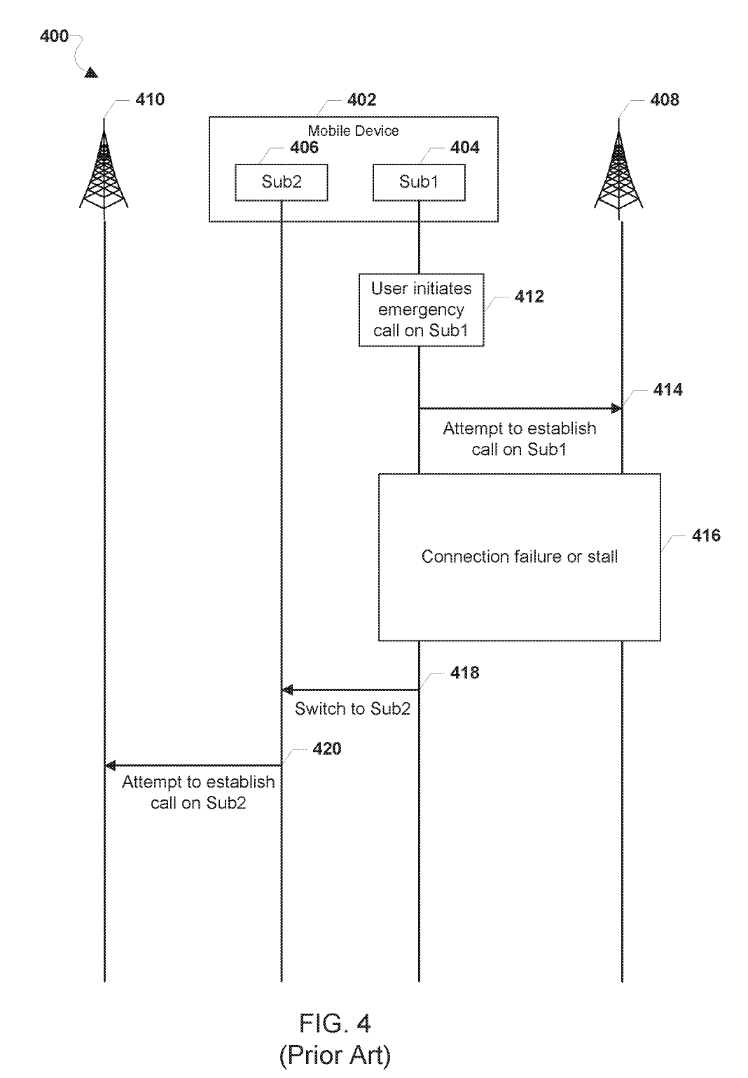

FIG. 4 includes a call flow diagram 400 illustrating performance of an emergency call on a mobile communication device 402 according to conventional methods. The mobile communication device 402 may include two or more SIMs that support a first subscription 404 and a second subscription 406. The first subscription 404 may communicate with a first network 408 through one or more RATs (e.g., LTE). The second subscription 406 may communicate with a second network 410 through one or more RATs (e.g., GSM, CDMA). The mobile communication device 402 may be an MSMS mobile communication device and the first subscription 404 and the second subscription 406 share a RF resource. Alternatively, the mobile communication device 402 may be an MSMA mobile communication device and the first subscription 404 and the second subscription 406 each utilize independent RF resources for communication.

A user may initiate an emergency call on the first subscription 404 in operation 412. The first subscription 404 may be currently active on the mobile communication device 402. The mobile communication device 402 may store a database of emergency numbers in memory. If the number that the user dials matches one of the emergency numbers, the mobile communication device 402 may identify the call as an emergency call.

The first subscription 404 may attempt to establish the emergency call through the first network 408 in communications 414. However, the first subscription 404 may experience a connection failure or stall in communications 416. For example, the mobile communication device 402 may be located in an area with poor reception from the first network 408, or the first network 408 may be experiencing network traffic congestion. If a connection failure occurs, the first subscription 404 may re-attempt the connection one or more times until a permanent failure is declared. In the case of a stall, the first subscription 404 may be stalled for a relatively long time (several seconds) before timing out. As an example, if the emergency call attempt for the first subscription 404 includes registration (e.g. IMS emergency registration) of the first subscription 404 in a home network for the first subscription 404, significant delay may occur (e.g. 10 to 30 seconds) if the home network for the first subscription 404 is congested or otherwise unable to complete the registration in a timely manner. In either case, the emergency call may not be established for a period of time long enough to have serious consequences in emergency situations.

If the first subscription 404 is not successful in establishing the emergency call after a period of time, the upper layers of the modem (e.g., the RR sublayers 308a, 308b) in the mobile communication device 402 may switch the emergency call from the first subscription 404 to the second subscription 406 in operation 418. If the mobile communication device 402 is an MSMS mobile device, operation 418 may include tuning the shared RF resource from the first subscription 404 to the second subscription 406. If the mobile communication device 402 is an MSMA device, the second subscription 406 may utilize its dedicated RF resource to attempt the emergency call. Either way, the second subscription 406 may attempt to establish the emergency call through the second network 410 in communications 420. Thus, as shown in FIG. 4, if the first subscription 404 cannot immediately establish the emergency call, there may be a significant delay before the call can be completed via the second subscription 406.

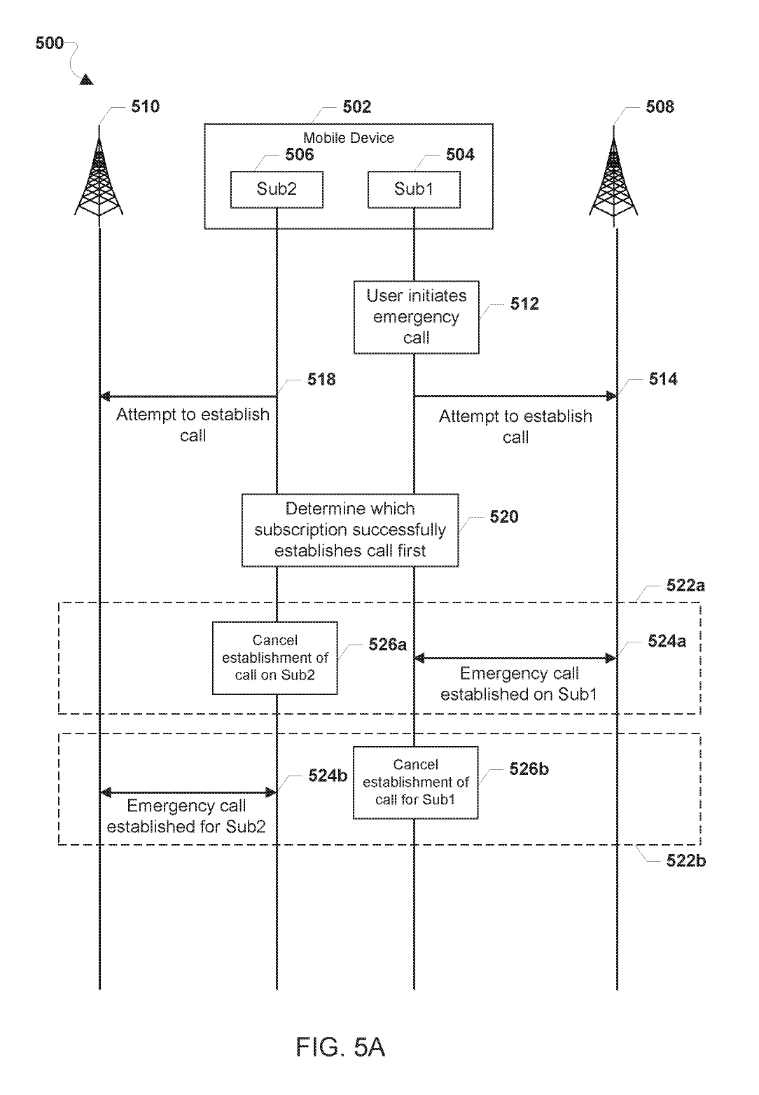

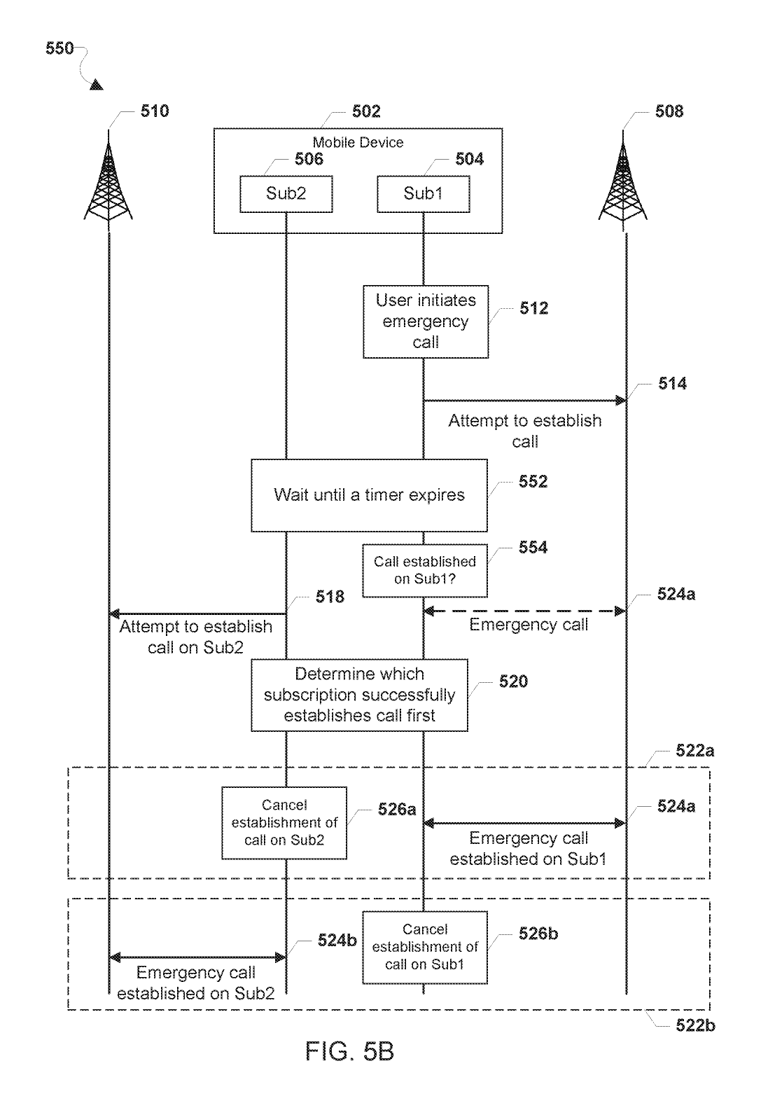

Various examples may improve the likelihood that an emergency call is completed quickly by utilizing multiple subscriptions in parallel on a multi-SIM mobile communication device. As illustrated in the call flow diagram 500 in FIG. 5A, when a user initiates an emergency call, the mobile communication device 502 may attempt to establish the call on multiple subscriptions simultaneously or with a small delay. Whichever subscription is able to establish the call first becomes the active subscription. This reduces the likelihood that stalls or connection failures delay successful completion of an emergency call.

The mobile communication device 502 may include two or more SIMs that support a first subscription 504 and a second subscription 506. The first subscription 504 may communicate with a first network 508 through one or more RATs (e.g., LTE). The second subscription 406 may communicate with a second network 510 through one or more RATs (e.g., GSM, CDMA). In some examples, the mobile communication device 502 may be an MSMS mobile communication device and the first subscription 504 and the second subscription 506 share a RF resource. In some examples, the mobile communication device 502 may be an MSMA mobile communication device and the first subscription 504 and the second subscription 506 each utilize independent RF resources for communication. The mobile communication device may have additional subscriptions not shown in FIG. 5A. In some examples, the first network 508 and the second network 510 may be the same network. In some other embodiments, the first network 508 and the second network 510 may include different radio access networks supporting different RATs but belonging to the same network operator.

A user may initiate an emergency call on the first subscription 504 in operation 512. The first subscription 504 may be currently active on the mobile communication device 502. The mobile communication device 502 may store a database of emergency numbers. If the number that the user dials matches one of the emergency numbers (e.g., 911), the mobile communication device 502 may identify the call as an emergency call.

The first subscription 504 may attempt to establish the emergency call through the first network 508 in communications 514. Establishment of the emergency call for the first subscription 504 in communications 514 may include one or more of: attaching to the first network 508; obtaining emergency IP connectivity from the first network 508; performing an IP multimedia subsystem (IMS) emergency registration with the first network 508 (and with the home network for the first subscription 504 if different to the first network 508); and sending an emergency call request (e.g. a Session Initiation Protocol (SIP) INVITE message) to a Public Safety Answering Point (PSAP) via the first network 508. The second subscription 506 may also attempt to establish the emergency call through the second network 510 in communications 518. Communications 518 may be similar to or the same as communications 514 except for identifying the second subscription 506 as the originator instead of the first subscription 504. In some examples, communications 514 and 518 are performed at the same time or one soon after the other so that the call attempts may be pending simultaneously. In other words, both the first subscription 504 and the second subscription 506 may attempt to independently establish the emergency call such that the two call attempts overlap in time.

If the mobile communication device 502 is an MSMA mobile device, the first subscription 504 and the second subscription 506 each have dedicated RF resources for establishing the emergency call. For example, the first subscription 504 may utilize one or more RATs (e.g., LTE) to communicate with the first network 508, and the second subscription 506 may utilize one or more RATs (e.g., GSM, CDMA) to communicate with the second network 510. If the mobile communication device 502 is an MSMS mobile device, the first subscription 504 may utilize the shared RF resource to establish the emergency call. The second subscription 506 may utilize a Wi-Fi connection or another local area network (LAN) connection to establish the emergency call.

The mobile communication device 502 may determine which subscription successfully establishes the emergency call first in operation 520. The upper layers of the modem (e.g., the RR sublayers 308a, 308b) may monitor the call connect state of both the first subscription 504 and the second subscription 506 to determine which subscription establishes the call first. If the mobile communication device 502 waits for a timer to expire before attempting to establish the emergency call on the second subscription 506, when the timer expires the mobile communication device 502 may determine whether the first subscription 504 has successfully established the emergency call before attempting to establish the emergency call on the second subscription 506.

In case 522a, the first subscription 504 successfully establishes the emergency call before the second subscription 506 in communications 524a. When this occurs, the second subscription 506 may cancel establishment of the emergency call on the second subscription 506 in operation 526a. For example, the second subscription 506 may deactivate the call, detach from the second network 510 and/or send an indication to the second network 510 or to a PSAP accessed via the second network 510 that an emergency call was successfully established using a different subscription and/or different network.

In case 522b, the second subscription 506 successfully establishes the emergency call before the first subscription 504 in communications 524b. When this occurs, the first subscription 504 may cancel establishment of the emergency call on the first subscription 504 in operation 526b. For example, the first subscription 504 may deactivate the call, detach from the first network 508 and/or send an indication to the first network 508 or to a PSAP accessed via the first network 508 that an emergency call was successfully established using a different subscription and/or different network. In this manner, both subscriptions on the mobile communication device 502 are utilized to enable quick completion of an emergency call.

In some examples as illustrated in the call flow diagram 550 in FIG. 5B, the mobile communication device 502 wait for a brief period after initiating the emergency call on the first subscription 504 before initiating an overlapping emergency call on the second subscription 506. This brief delay before initiating the second attempt provides an opportunity for the call to be established on the first subscription 504 (e.g., on a first attempt) before the second attempt is made, but ensures that the attempt on the second subscription 506 is initiated before a call failure is declared on the first subscription 504. Thus, the examples in method 550 illustrated in FIG. 5B may reduce network activity when the emergency call is promptly completed on the first subscription 504 while avoiding a long delay in establishing the emergency call on the second subscription 506 when the attempts on the first subscription 504 are unsuccessful.

As illustrated in FIG. 5B, the method 550 may include the operations and communications 512-522b of the method 500 described with reference to FIG. 5A. Additionally, in operation 552 the processor may start a timer upon initiating the emergency call on the first subscription 504 and wait until the timer expires before attempting to establish the emergency call on the second subscription 506 in communications 518. The timer may be on the order of a few seconds, for example between 5-20 seconds. Delaying the attempts to establish the emergency call on the second subscription 506 in operation 552 may allow the first subscription 504 an opportunity to establish the emergency call within the duration of the timer. Upon expiration of the timer, the processor may determine in operation 554 whether the emergency call was established on the first subscription 504. If the first subscription 504 successfully establishes the emergency call quickly (i.e., within the duration of the timer), then the emergency call 524a may be conducted on the first subscription and the second subscription 506 does not attempt to establish the emergency call. However, if the first subscription 504 has not yet established the emergency call, the emergency call is attempted on the second subscription in communications 518 as described.

The mobile communication device 502 is not limited to two SIM/subscriptions as illustrated in FIG. 5. For example, the mobile communication device 502 may have three, four, or more SIMs/subscriptions. An emergency call may be simultaneously or near simultaneously attempted on any number of subscriptions supported by the mobile communication device 502. In some examples, the mobile communication device 502 may have the capability to support multiple SIMs/subscriptions but have a single SIM/subscription inserted. In this case, an emergency call may still be attempted simultaneously through additional subscriptions even though additional SIMs have not been inserted. In some examples, the mobile communication device 502 may attempt the emergency call through a Wi-Fi connection in addition to one or more subscriptions.

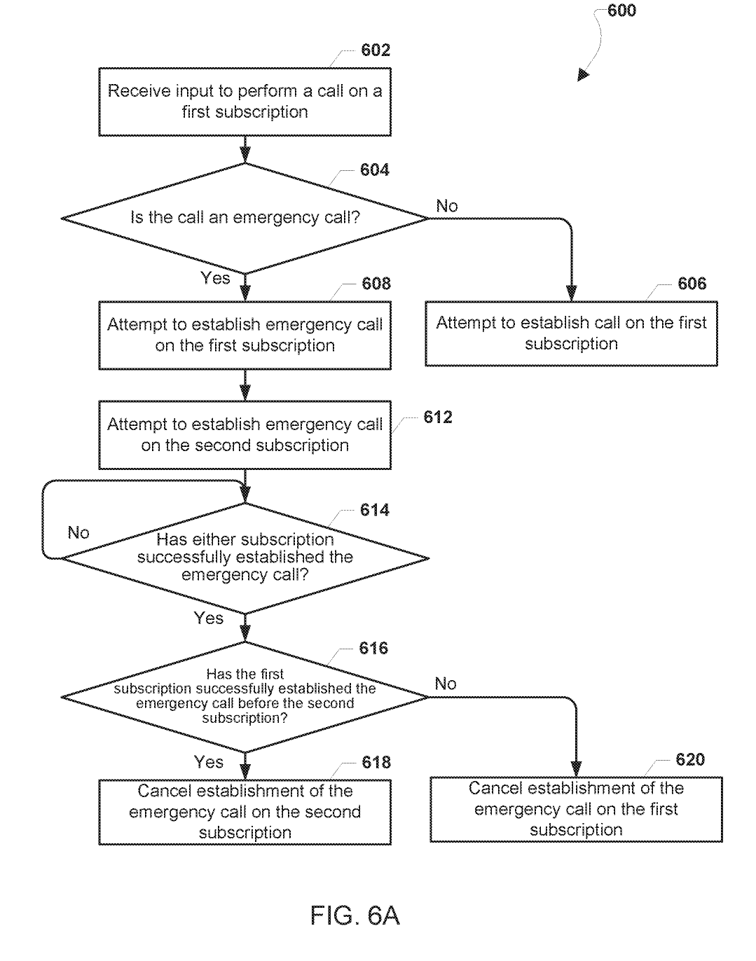

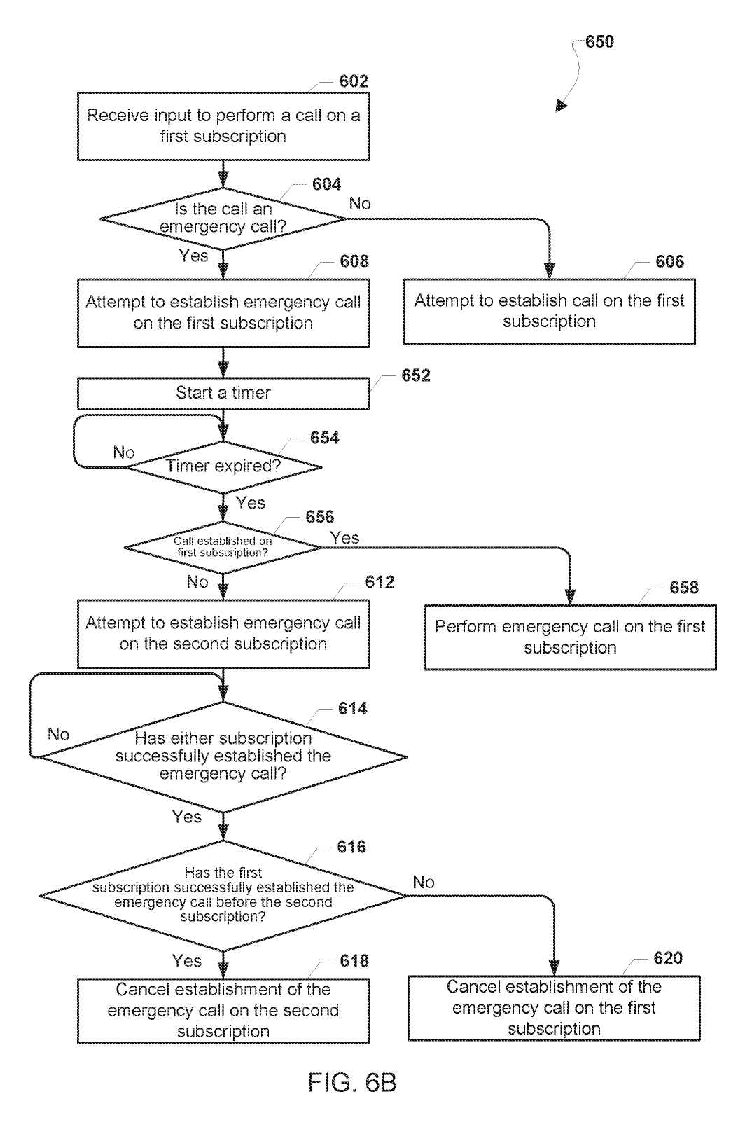

FIG. 6A illustrates a method 600 for performing an emergency call on a mobile communication device according to various examples. The method 600 may be implemented with a processor (e.g., the general processor 206, the baseband modem processor 216, a separate controller, and/or the like) of a mobile communication device (such as the mobile communication devices 110, 120, 200, 502) that supports one or more SIMs/subscriptions. For example, the mobile communication device may be an MSMS mobile device or an MSMA mobile device having a first subscription and a second subscription. The mobile communication device may have additional subscriptions.

In block 602, the processor may receive an input from a user of the mobile communication device to perform a call on the first subscription. For example, the user may dial a phone number for an outgoing voice call. In determination block 604, the processor may determine whether the call is an emergency call. The mobile communication device may store a database of emergency numbers. If the number of the call matches an emergency number, then the call is an emergency call. In response to determining that the call is not an emergency call (i.e., determination block 604=“No”), the processor may attempt to establish the call on the first subscription in block 606. In other words, if the call is a non-emergency call then the processor may perform the call on the first subscription as usual.

In response to determining that the call is an emergency call (i.e., determination block 604=“Yes”), the processor may attempt to establish the call on the first subscription in block 608. Establishment of the emergency call may include one or more of: attaching to a first network associated with the first subscription; obtaining emergency IP connectivity from the first network; performing an IP multimedia subsystem (IMS) emergency registration with the first network (and with the home network for the first subscription if different to the first network); and sending an emergency call request (e.g. a Session Initiation Protocol (SIP) INVITE message) to a Public Safety Answering Point (PSAP) via the first network.

In block 612, the processor may attempt to establish the emergency call on the second subscription. The processor may attempt to establish the emergency call on the second subscription in block 612 at the same time or immediately after attempting to establish the emergency call on the first subscription in block 608 (i.e., perform the operations in blocks 608 and 612 so that the network processes of initiating and completing the call overlap in time). If the mobile communication device is an MSMA device, the first subscription and the second subscription may each have dedicated RF resources that may be used to attempt to establish the emergency call. For example, each subscription may utilize one or more RATs (e.g., LTE, GSM, CDMA) to communicate with their respective networks. If the mobile communication device is an MSMS device, the first subscription may utilize the shared RF resource to attempt to establish the emergency call and the second subscription may utilize a Wi-Fi connection or another LAN connection to attempt to establish the emergency call. In some examples, the processor may attempt to establish the emergency call on the second subscription even though the mobile communication device includes one SIM. In other words, an emergency call may be attempted on a subscription even if the SIM slot is empty. In some examples, the processor may attempt to establish the emergency call on any number of additional subscriptions. In some examples, the processor may attempt to establish the emergency call through a Wi-Fi connection in addition to the first subscription.

In determination block 614, the processor may determine whether either the first subscription or the second subscription has successfully established the emergency call. The upper layers of the modem in the mobile communication device (e.g., the RR sublayers 308a, 308b) may monitor the call connect state of both subscriptions to determine if at least one of them has successfully established the call.

In response to determining that neither the first subscription nor the second subscription has successfully established the emergency call (i.e., determination block 614=“No”), the processor may continue to monitor the first subscription and the second subscription to determine whether either subscription has successfully established the emergency call (i.e., repeat the operations in determination block 614).

In response to determining that either the first subscription or the second subscription has successfully established the emergency call (i.e., determination block 614=“Yes”), the processor may determine whether the first subscription has successfully established the emergency call before the second subscription in determination block 616. In some examples, determining whether either subscription has established the emergency call (determination block 614) and identifying the subscription that established the call (determination block 616) may be accomplished in a single operation.

In response to determining that the first subscription has successfully established the emergency call before the second subscription (i.e., determination block 616=“Yes”), the processor may cancel establishment of the emergency call on the second subscription in block 618. For example, the processor may deactivate the emergency call, detach from the second network and/or send an indication to the second network or to a PSAP accessed via the second network that an emergency call was successfully established using a different subscription and/or different network. In response to determining that the second subscription has successfully established the emergency call before the first subscription (i.e., determination block 616=“No”), the processor may cancel establishment of the emergency call on the first subscription in block 620. For example, the processor may deactivate the emergency call, detach from the first network and/or send an indication to the first network or to a PSAP accessed via the first network that an emergency call was successfully established using a different subscription and/or different network. In this manner, the method 600 provides a way to increase the likelihood of successfully completing an emergency call by utilizing multiple subscriptions in parallel to establish the call.

As described, in some examples one subscription may be given a brief period to attempt the emergency call before the other subscription attempts the call in order to avoid the second call attempt if the first call attempt is immediately successful. FIG. 6B illustrates a method 650 for performing an emergency call on a mobile communication device implementing such a delay between simultaneous calls according to various examples. The method 650 may be implemented with a processor (e.g., the general processor 206, the baseband modem processor 216, a separate controller, and/or the like) of a mobile communication device (such as the mobile communication devices 110, 120, 200, 502) that supports two or more SIMs/subscriptions. For example, the mobile communication device may be an MSMS mobile device or an MSMA mobile device having a first subscription and a second subscription. The mobile communication device may have additional subscriptions.

The method 650 may include the operations of blocks 602-608 and blocks 612-620 of the method 600 described with reference to FIG. 5B.

Upon attempting the emergency call on the first subscription in block 608 as described with reference to the method 600, the processor may start a timer in block 652. The timer may be on the order of a few seconds (e.g.,) configured allow time for the first subscription to quickly establish the emergency call before attempting the emergency call on the second subscription as well. In some examples, the timer may be between approximately 5 seconds and approximately 20 seconds.

The processor may monitor the timer, such as in by determining whether the timer has expired in determination block 654. In response to determining that the timer has not expired (i.e., determination block 654=“No”), the processor may continue to wait for the timer to expire (i.e., return to the operations in determination block 654).

In response to determining that the timer has expired (i.e., determination block 654=“Yes”), the processor may determine whether the emergency call has been established on the first subscription in determination block 656. For example, the upper layers of the modem may determine the call connect state of the first subscription.

In response to determining that the emergency call has successfully established on the first subscription (i.e., determination block 656=“Yes”), the processor may perform the emergency call on the first subscription in block 658. With the call established on the first subscription, there is no need to attempt the emergency call on the second subscription.

In response to determining that the emergency call has not successfully established on the first subscription (i.e., determination block 656=“No”), the processor may attempt to establish the emergency call on the second subscription in block 612 and monitor the subscriptions to detect when the emergency call is established and cancel the attempt on the other subscription in blocks 614-620 of the method 600 as described with reference to FIG. 6A.

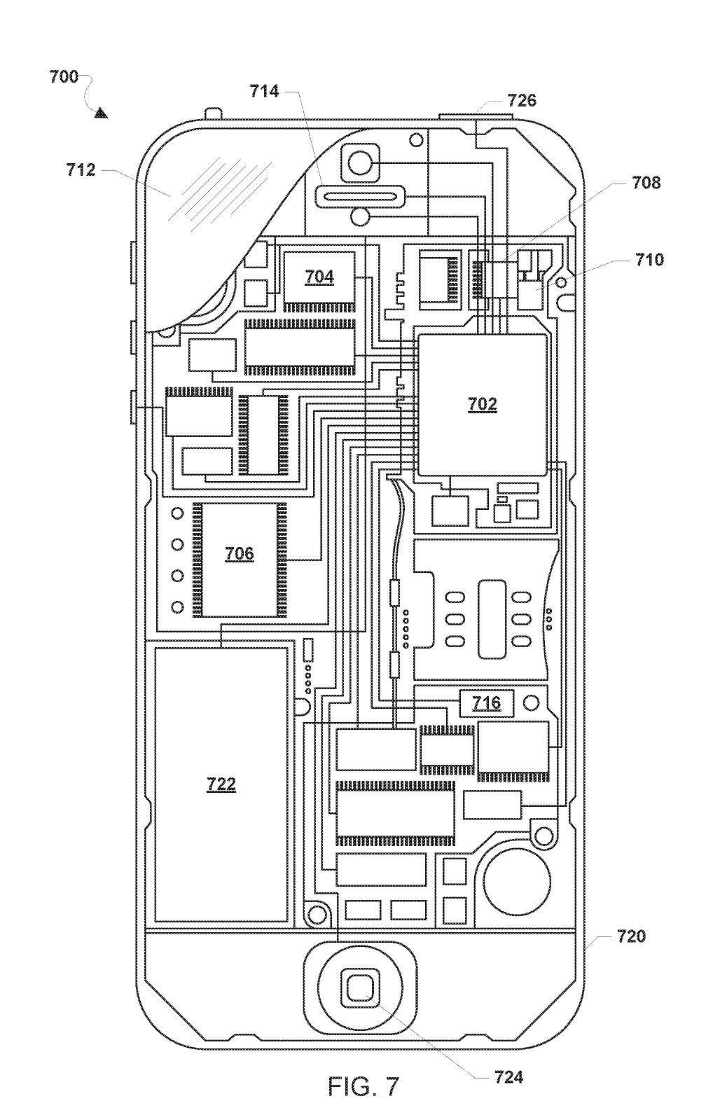

Various examples may be implemented in any of a variety of communication devices, an example of which (e.g., multi-SIM mobile communication device 700) is illustrated in FIG. 7. The multi-SIM mobile communication device 700 may be similar to the mobile communication devices 110, 120, 200, 502 as described. As such, the multi-SIM mobile communication device 700 may implement the method 600 according to various examples.

The multi-SIM mobile communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the multi-SIM mobile communication device 700 need not have touch screen capability.

The multi-SIM mobile communication device 700 may have one or more cellular network transceivers 708 coupled to the processor 702 and to one or more antennas 710 and configured for sending and receiving cellular communications. The one or more transceivers 708 and the one or more antennas 710 may be used with the herein-mentioned circuitry to implement various example methods. The multi-SIM mobile communication device 700 may include one or more SIM cards 716 coupled to the one or more transceivers 708 and/or the processor 702 and may be configured as described herein.

The multi-SIM mobile communication device 700 may also include speakers 714 for providing audio outputs. The multi-SIM mobile communication device 700 may also include a housing 720, constructed of a plastic, metal, or a combination of materials, for containing all or some of the components discussed herein. The multi-SIM mobile communication device 700 may include a power source 722 coupled to the processor 702, such as a disposable or rechargeable battery. The rechargeable battery may also be coupled to the peripheral device connection port to receive a charging current from a source external to the multi-SIM mobile communication device 700. The multi-SIM mobile communication device 700 may also include a physical button 724 for receiving user inputs. The multi-SIM mobile communication device 700 may also include a power button 726 for turning the multi-SIM mobile communication device 700 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the operations of various examples must be performed in the order presented. As will be appreciated by one of skill in the art the order of operations in the foregoing examples may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the examples disclosed herein may be implemented as electronic hardware, computer software, or combinations of both. To clearly illustrate this interchangeability of hardware and software, various illustrative components, blocks, modules, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present examples.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more example aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present examples. Various modifications to these examples will be readily apparent to those skilled in the art, and the generic principles defined herein may be applied to some examples without departing from the spirit or scope of the written description. Thus, the present disclosure is not intended to be limited to the examples shown herein but is to be accorded the widest scope consistent with the following claims and the principles and novel features disclosed herein.

What is claimed is:

1. A method for performing an emergency call on a mobile communication device having a first subscription and a second subscription, comprising:
receiving, from a user, an input to perform the emergency call on the first subscription;
attempting to establish the emergency call on the first subscription;
attempting to establish the emergency call on the second subscription;
determining whether the emergency call has been established on either the first subscription or the second subscription;
completing the emergency call on the first subscription and cancelling the attempt to establish the emergency call on the second subscription in response to determining that the emergency call has been established on the first subscription; and
completing the emergency call on the second subscription and cancelling the attempt to establish the emergency call on the first subscription in response to determining that the emergency call has been established on the second subscription.

2. The method of claim 1, further comprising:
waiting for a timer to expire between attempting to establish the emergency call on the first subscription and attempting to establish the emergency call on the second subscription.

3. The method of claim 2, wherein waiting for the timer to expire comprises:
starting the timer upon attempting to establish the emergency call on the first subscription; and
determining whether the first subscription has successfully established the emergency call after the timer expires;
wherein attempting to establish the emergency call on the second subscription is performed in response to determining that the first subscription has not successfully established the emergency call after expiry of the timer.

4. The method of claim 1, wherein attempting to establish the emergency call on the first subscription and attempting to establish the emergency call on the second subscription are performed approximately simultaneously.

5. The method of claim 1, further comprising:
continuing to attempt to establish the emergency call on the first subscription and on the second subscription in response to determining that the emergency call has not been established on either the first subscription or the second subscription.

6. The method of claim 1, wherein the mobile communication device is a multi-subscriber identity module (SIM), multi-active mobile communication device, and attempting to establish the emergency call on the first subscription and attempting to establish the emergency call on the second subscription are performed using respective radio frequency resources.

7. The method of claim 1, wherein the mobile communication device is a multi-subscriber identity module (SIM), multi-standby mobile communication device, and attempting to establish the emergency call on the second subscription is performed over a wireless local area network connection.

8. The method of claim 1, wherein cancelling the attempt to establish the emergency call on the first subscription or the second subscription comprises deactivating the emergency call.

9. A mobile communication device, comprising:
a memory;
a radio frequency (RF) resource; and
a processor coupled to the memory and the RF resource, configured to connect to a first subscriber identity module (SIM) associated with a first subscription and a second SIM associated with a second subscription, and configured to:
receive, from a user, an input to perform an emergency call on the first subscription;
attempt to establish the emergency call on the first subscription;
attempt to establish the emergency call on the second subscription;
determine whether the emergency call has been established on either the first subscription or the second subscription;
complete the emergency call on the first subscription and cancelling the attempt to establish the emergency call on the second subscription in response to determining that the emergency call has been established on the first subscription; and
complete the emergency call on the second subscription and cancelling the attempt to establish the emergency call on the first subscription in response to determining that the emergency call has been established on the second subscription.

10. The mobile communication device of claim 9, wherein the processor is further configured to:
wait for a timer to expire between attempting to establish the emergency call on the first subscription and attempting to establish the emergency call on the second subscription.

11. The mobile communication device of claim 10, wherein the processor is configured to wait for the timer to expire by:
starting the timer upon attempting to establish the emergency call on the first subscription; and
determining whether the first subscription has successfully established the emergency call after the timer expires;
wherein attempting to establish the emergency call on the second subscription is performed in response to determining that the first subscription has not successfully established the emergency call after expiry of the timer.

12. The mobile communication device of claim 9, wherein the processor is configured such that attempting to establish the emergency call on the first subscription and attempting to establish the emergency call on the second subscription are performed approximately simultaneously.

13. The mobile communication device of claim 9, wherein the processor is further configured to:
continue to attempt to establish the emergency call on the first subscription and on the second subscription in response to determining that the emergency call has not been established on either the first subscription or the second subscription.

14. The mobile communication device of claim 9, wherein the mobile communication device is a multi-subscriber identity module (SIM), multi-active mobile communication device, and attempting to establish the emergency call on the first subscription and attempting to establish the emergency call on the second subscription are performed using respective radio frequency resources.

15. The mobile communication device of claim 9, wherein the mobile communication device is a multi-subscriber identity module (SIM), multi-standby mobile communication device, and attempting to establish the emergency call on the second subscription is performed over a wireless local area network connection.

16. The mobile communication device of claim 9, wherein the processor is configured to cancel the attempt to establish the emergency call on the first subscription or the second subscription by deactivating the emergency call.

17. A non-transitory computer readable storage medium having stored thereon processor-executable software instructions configured to cause a processor of a mobile communication device to perform operations comprising:
receiving, from a user, an input to perform an emergency call on a first subscription of the mobile communication device;
attempting to establish the emergency call on the first subscription;
attempting to establish the emergency call on a second subscription of the mobile communication device;
determining whether the emergency call has been established on either the first subscription or the second subscription;
completing the emergency call on the first subscription and cancelling the attempt to establish the emergency call on the second subscription in response to determining that the emergency call has been established on the first subscription; and
completing the emergency call on the second subscription and cancelling the attempt to establish the emergency call on the first subscription in response to determining that the emergency call has been established on the second subscription.

18. The non-transitory computer readable storage medium of claim 17, wherein the stored processor-executable instructions are configured to cause the processor of the mobile communication device to perform operations further comprising:
waiting for a timer to expire between attempting to establish the emergency call on the first subscription and attempting to establish the emergency call on the second subscription.

19. The non-transitory computer readable storage medium of claim 18, wherein the stored processor-executable instructions are configured to cause the processor of the mobile communication device to perform operations such that waiting for the timer to expire comprises:
starting the timer upon attempting to establish the emergency call on the first subscription; and
determining whether the first subscription has successfully established the emergency call after the timer expires;
wherein attempting to establish the emergency call on the second subscription is performed in response to determining that the first subscription has not successfully established the emergency call after expiry of the timer.

20. The non-transitory computer readable storage medium of claim 17, wherein the stored processor-executable instructions are configured to cause the processor of the mobile communication device to perform operations such that attempting to establish the emergency call on the first subscription and attempting to establish the emergency call on the second subscription are performed approximately simultaneously.

21. The non-transitory computer readable storage medium of claim 17, wherein the stored processor-executable instructions are configured to cause the processor of the mobile communication device to perform operations further comprising:
continuing to attempt to establish the emergency call on the first subscription and on the second subscription in response to determining that the emergency call has not been established on either the first subscription or the second subscription.

22. The non-transitory computer readable storage medium of claim 17, wherein the mobile communication device is a multi-subscriber identity module (SIM), multi-active mobile communication device, and attempting to establish the emergency call on the first subscription and attempting to establish the emergency call on the second subscription are performed using respective radio frequency resources.

23. The non-transitory computer readable storage medium of claim 17, wherein the mobile communication device is a multi-subscriber identity module (SIM), multi-standby mobile communication device, and attempting to establish the emergency call on the second subscription is performed over a wireless local area network connection.

24. A mobile communication device, comprising:
means for receiving, from a user, an input to perform an emergency call on a first subscription of the mobile communication device;
means for attempting to establish the emergency call on the first subscription;
means for attempting to establish the emergency call on a second subscription of the mobile communication device;
means for determining whether the emergency call has been established on either the first subscription or the second subscription;
means for completing the emergency call on the first subscription and cancelling the attempt to establish the emergency call on the second subscription in response to determining that the emergency call has been established on the first subscription; and
means for completing the emergency call on the second subscription and cancelling the attempt to establish the emergency call on the first subscription in response to determining that the emergency call has been established on the second subscription.

25. The mobile communication device of claim 24, further comprising:
means for waiting for a timer to expire between attempting to establish the emergency call on the first subscription and attempting to establish the emergency call on the second subscription.

26. The mobile communication device of claim 25, wherein the means for waiting for the timer to expire comprises:
means for starting the timer upon attempting to establish the emergency call on the first subscription; and
means for determining whether the first subscription has successfully established the emergency call after the timer expires;
means for wherein attempting to establish the emergency call on the second subscription is performed in response to determining that the first subscription has not successfully established the emergency call after expiry of the timer.

27. The mobile communication device of claim 24, wherein the means for attempting to establish the emergency call on the first subscription and attempting to establish the emergency call on the second subscription are performed approximately simultaneously.

28. The mobile communication device of claim 24, further comprising:
means for continuing to attempt to establish the emergency call on the first subscription and on the second subscription in response to determining that the emergency call has not been established on either the first subscription or the second subscription.

29. The mobile communication device of claim 24, wherein the mobile communication device is a multi-subscriber identity module (SIM), multi-active mobile communication device, and attempting to establish the emergency call on the first subscription and attempting to establish the emergency call on the second subscription are performed using respective radio frequency resources.

30. The mobile communication device of claim 24, wherein the mobile communication device is a multi-subscriber identity module (SIM), multi-standby mobile communication device, and attempting to establish the emergency call on the second subscription is performed over a wireless local area network connection.
